(19) United States
(12) Patent Application Publication
(10) Pub. No.: US 2011/0216027 A1
(43) Pub. Date: Sep. 8, 2011

(54) Haptic feedback device and electronic device

(75) Inventors: Jae Kyung Kim, Ansan (KR); Dae Woong Yun, Incheon (KR); Su Young Jung, Yongin (KR); Ki Suk Woo, Seoul (KR); Kum Kyung Lee, Suwon (KR); Dong Sun Park, Seoul (KR); Yeon Ho Son, Hwaseong (KR); Ji Yeoun Jang, Suwon (KR)

(73) Assignee: Samsung Electro-Mechanics Co., Ltd., Suwon (KR)

(21) Appl. No.: 13/064,061

(22) Filed: Mar. 3, 2011

(30) Foreign Application Priority Data
Mar. 4, 2010 (KR) 10-2010-0019401

(51) Int. Cl. G08B 6/00

(52) U.S. Cl. 345/173

(57) ABSTRACT

Disclosed are a haptic feedback device and an electronic device. The haptic feedback device includes: a haptic device to which contact pressure is applied; an actuator provided in the haptic device and excited according to a change in the contact pressure of the haptic device to generate vibrations; and a controller controlling the actuator to vibrate at a pre-set resonance frequency in a pre-set first operation mode and vibrate at a driving frequency different from the resonance frequency in a second operation mode set to be different from the first operation mode.

### CROSS-REFERENCE TO RELATED APPLICATIONS

This application claims the priority of Korean Patent Application No. 10-2010-0019401 filed on Mar. 4, 2010, in the Korean Intellectual Property Office, the disclosure of which is incorporated herein by reference.

### BACKGROUND OF THE INVENTION

1. Field of the Invention

The present invention relates to a haptic feedback device and an electronic device, and more particularly, to a haptic feedback device and an electronic device for generating vibrations at a pre-set resonance frequency or at a driving frequency different from the resonance frequency according to operation modes.

2. Description of the Related Art

Recently, a touch-type device, namely, a haptic device, allowing for touch-input in electronic products has been generalized to meet consumers' demand for the simplification of the use of electronic devices.

A haptic feedback device involves a concept for reflecting users' intuitional experiences on interfaces and diversifying touch feedbacks, as well as a concept of touch-inputting.

The haptic feedback device has many advantages: it allows for space saving, provides improved operability and simplicity; its specification can be simply changed to increase user recognition; and it facilitates interworkability with an IT device, and the like.

With such advantages, the haptic feedback device is extensively used for electronic devices used in the computing, traffic management, service, medical, and mobile fields.

In general, the related electronic device employs a vibration motor to implement a haptic function. However, because the vibration motor is devised to vibrate the overall electronic device, it has a problem in that the size of the mass must be increased in order to strengthen the vibration force thereof.

Also, the vibration motor has additional inefficiency problems, in that it cannot evade an increase in its unit cost, it must be disposed in a limited internal space of the electronic device, and it consumes a great deal of power to vibrate the overall electronic device.

In addition, as user interfaces are advancing and the functions of electronic devices are becoming diversified and complicated, the vibration motor for vibrating the overall electronic device does not fit to implement various types of feedback for various functions.

### SUMMARY OF THE INVENTION

An aspect of the present invention provides a haptic feedback device and an electronic device for generating vibrations at a pre-set resonance frequency or at a driving frequency different from the resonance frequency according to operation modes.

According to an aspect of the present invention, there is provided a haptic feedback device including: a haptic device to which contact pressure is applied; an actuator provided in the haptic device and excited according to a change in the contact pressure of the haptic device to generate vibrations; and a controller controlling the actuator to vibrate at a pre-set resonance frequency in a pre-set first operation mode and vibrate at a driving frequency different from the resonance frequency in a second operation mode set to be different from the first operation mode.

The driving frequency may be lower than the resonance frequency or 50 Hz or higher, or may be higher than the resonance frequency or 500 Hz or lower.

The actuator may be disposed at a central portion of the haptic device.

The actuator may be disposed at a central portion of an edge portion in a lengthwise direction of the haptic device.

The central portion, at which the actuator is disposed, may be within the range of 20 percent to 80 percent of the overall length of the haptic device from one end portion to the other end portion of the haptic device.

The actuator may be a piezo actuator or a polymer actuator.

The haptic feedback device may further include: a vibration plate interposed between the haptic device and the actuator and transferring vibrations generated from the actuator to the haptic device.

The vibration plate may include a plurality of ramification lines formed on the edge portion in a lengthwise direction of the haptic device, and the ramification lines may be demarcated by a slit.

The actuator may be attached to ramification lines and may be disposed to be parallel to the ramification lines.

According to an aspect of the present invention, there is provided an electronic device including: a case having an internal space; a display panel disposed within the case; an actuator excited according to a change in contact pressure of the display panel to generate vibrations; and a controller controlling the actuator to vibrate at a pre-set resonance frequency in a pre-set first operation mode and vibrate at a driving frequency different from the resonance frequency in a second operation mode set to be different from the first operation mode.

The driving frequency may be lower than the resonance frequency or 50 Hz or higher, or may be higher than the resonance frequency or 500 Hz or lower.

The actuator may be disposed at an edge portion in a lengthwise direction of the display panel.

A central portion of the edge portion, at which the actuator is disposed, may be within the range of 20 percent to 80 percent of the overall length of the display panel from one end portion to the other end portion of the display panel.

The electronic device may further include: a vibration plate interposed between the display panel and the actuator and transferring vibrations generated from the actuator to the display panel.

The vibration plate may include a plurality of ramification lines formed on the edge portion in a lengthwise direction of the display panel, and the ramification lines may be demarcated by a slit.

The actuator may be attached to ramification lines and may be disposed to be parallel to the ramification lines.

The actuator may be a piezo actuator or a polymer actuator.

The piezo actuator may be a ceramic laminated body, and polling of the ceramic laminated body may be formed in the same direction.

The actuator may be disposed at a central portion of the display panel.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view of a mobile communication terminal, an electronic device, according to an exemplary embodiment of the present invention;

FIG. 2 is a perspective view showing a haptic feedback device mounted in a mobile communication terminal case according to an exemplary embodiment of the present invention;

FIG. 3 is a schematic perspective view of the haptic feedback device according to an exemplary embodiment of the present invention;

FIG. 4 is a graph showing the relationships between the frequency and response speed of the haptic feedback device according to an exemplary embodiment of the present invention;

FIGS. 5(a) and 5(b) are side views showing a change in the length of an actuator and a vibration plate of a haptic feedback actuator according to an exemplary embodiment of the present invention;

FIG. 6 is an enlarged sectional view of a portion of FIG. 5(b), showing how the haptic feedback actuator operates;

FIG. 7 is a graph of a displacement over vibration frequency of the haptic feedback actuator;

FIGS. 8(a) and 8(b) are schematic perspective views showing a change in the placement position of the actuator of the haptic feedback actuator according to an exemplary embodiment of the present invention;

FIG. 9 is a side view for explaining the placement position of the actuator according to an exemplary embodiment of the present invention;

FIG. 10 is a graph of a displacement over vibration frequency of the haptic feedback actuator of FIGS. 8(a) and 8(b);

FIG. 11 is a schematic sectional view showing how the haptic feedback device is bonded according to an exemplary embodiment of the present invention; and

FIG. 12 is a graph of a displacement over vibration frequency of the haptic feedback actuator measured according to types of bonding materials of the haptic feedback device according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

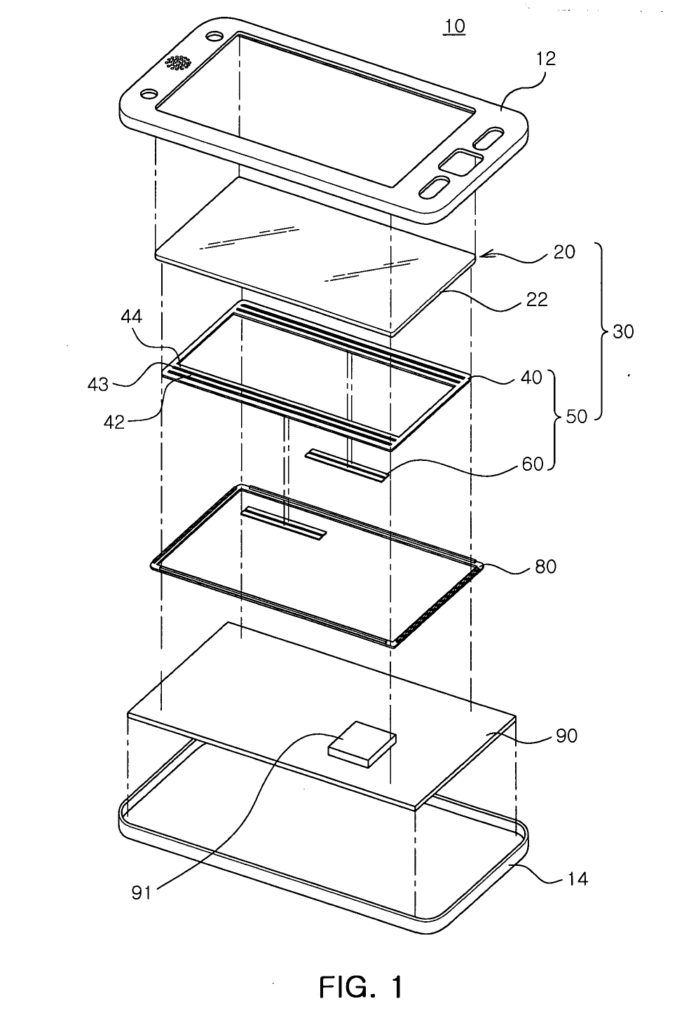

A haptic feedback actuator, and a haptic feedback device and an electronic device including the haptic feedback actuator according to exemplary embodiments of the present invention will now be described in detail with reference to FIGS. 1 to 12.

[Electronic Device]

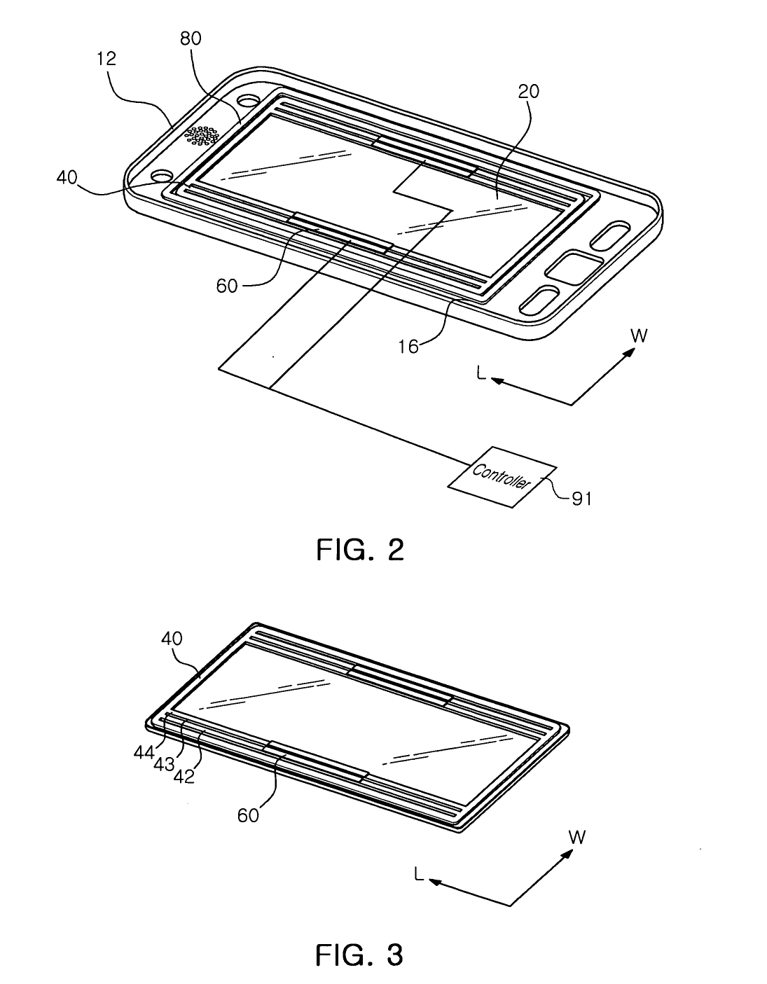

FIG. 1 is an exploded perspective view of a mobile communication terminal, an electronic device, according to an exemplary embodiment of the present invention. FIG. 2 is a perspective view showing a haptic feedback device mounted in a mobile communication terminal case according to an exemplary embodiment of the present invention. FIG. 3 is a schematic perspective view of the haptic feedback device according to an exemplary embodiment of the present invention.

As an electronic device according to an exemplary embodiment of the present invention, a mobile communication terminal 10 will be taken as an example, but the present invention is not limited thereto and may be applicable to any haptic device involving a vibration change according to user's contact therewith, such as various OA devices, medical devices, mobile communication devices, traffic note issuing devices, and the like.

Hereinafter, the mobile communication terminal 10 as an electronic device will be described in detail.

With reference to FIGS. 1 to 3, the mobile communication terminal 10, an electronic device, according to an exemplary embodiment of the present invention may include cases 12 and 14, a display panel 22, an actuator 60, and a vibration plate 40.

The cases 12 and 14 may include a front case 12 and a rear case 14, and an internal space is formed as the front and rear cases 12 and 14 are coupled. A rubber ring 80 may be provided in the internal space of the cases 12 and 14 along the circumference the cases 12 and 14.

The display panel 22 serving as a haptic device 20 and a circuit board 90 including a controller 91 formed thereon to drive a haptic feedback actuator 50 may be mounted within the internal space.

Here, the haptic device 20, an implement requiring vibration, is an internal constituent of the mobile communication terminal, an electronic device, which needs to react to external contact pressure.

The haptic device 20 may be an input device, an OA device, a vending machine, a bed, a card, an operating device, a ticket, and the like, as well as the display panel 22 of the mobile communication terminal, which needs vibration in response to a contact applied thereto according to an exemplary embodiment of the present invention,

In the present exemplary embodiment, the mobile communication terminal 10, an electronic device, uses the display panel 22, as the haptic device, providing an image. Namely, when contact pressure is changed as a contact is applied to the display panel 22, the display panel 22 itself is haptic-reacted to the contact.

In order for the display panel 22 to haptic-react to the contact, the actuator 60 must generate vibrations and, in this case, a vibration frequency is provided by the controller 91. A detailed vibration generation principle of the actuator 60 will be described later.

The vibration plate 40 may transfer vibrations generated by the actuator to the display panel 22. In this case, the actuator 60 may be directly attached to the display panel 22 to vibrate the display panel 22. However, the present invention is not meant to be limited thereto and the actuator 60 may be selectively used as necessary for easing an impact resulting from vibrations or the amplification of vibrations.

Namely, the vibration plate 40 may be obtained by injection-molding an impact-relieving material but is not limited thereto. Also, the thickness of the vibration plate 40 may be varied in consideration of interaction between the vibration plate 40 and the actuator 60. In this respect, the experimentation results show that vibrations greatly increase when the thickness of the vibration plate 40 is smaller than 0.2 mm, so the thickness of the vibration plate 40 may be appropriately selected according to a requirement range of vibrations.

The haptic feedback actuator and the haptic device will now be described in detail. Concrete characteristics of the haptic feedback actuator and the haptic device can be all applied to the electronic device according to an exemplary embodiment of the present invention.

[Haptic Feedback Actuator and Haptic Feedback Device]

The haptic feedback actuator 50 according to an exemplary embodiment of the present invention may include a vibration plate 40 and an actuator 60. Also, the haptic feedback device 30 may include the haptic device to which a contact-pressure is applied and the haptic feedback actuator 50 that vibrates the haptic device 20.

Here, the vibration plate 40 of the haptic feedback device 30 may be optional.

The vibration plate 40, which has been described above in detail in explaining the mobile communication terminal 10, may be attached to an edge portion configuring the haptic device 20.

Namely, as shown in FIG. 3, the vibration plate 40 may be formed as a thin strip along the edge portion of a rectangular shape of the display panel 22.

Here, a longer side of the display panel 22 in the rectangular shape is defined as a lengthwise direction, and a shorter side of the display panel 22 is defined as a widthwise direction.

In detail, the vibration plate 40 may have a plurality of ramification lines 42 and 44 at the edge portion in the lengthwise direction of the display panel 22, the haptic device 20, and a slit 43 may be formed between the plurality of ramification lines 42 and 44. In this case, the ramification lines 42 and 44 may have substantially the same width, and the actuator 60 having a bar-like shape and substantially the same width as that of the ramification lines 42 and 44 may be attached to be disposed. In this case, the actuator 60 may be disposed to be parallel to the ramification lines 42 and 44.

The actuator 60 may be configured as a piezo actuator or a polymer actuator and excited according to a change in a contact-pressure applied to the haptic device to generate vibrations. The controller 91 vibrates the actuator 60 at a predetermined frequency according to a pre-set operation mode. For example, the controller 91 may vibrate the actuator 60 at a resonance frequency in a first operation mode or may vibrate the actuator 60 at a driving frequency different from the resonance frequency in a second operation mode.

The first and second operation modes may be discriminated according to a required reaction speed. For example, the first operation mode may be a mode in which a call is received, and the second operation mode may be a mode in which characters are inputted or games, or the like, are played.

Namely, when a call is received in the first operation mode, strong vibrations, rather than a reaction speed, are preferred, so the controller 91 vibrates the actuator 60 at the resonance frequency at which vibration force is the strongest, whereas when characters are inputted or games are played, a reaction speed is of importance, so the controller 91 vibrates the actuator 60 at the driving frequency different from the resonance frequency.

Here, the resonance frequency refers to a resonance frequency unique to a material, which may be affected by the thickness, length, and number of the actuator(s) 60 as shown in Table 1 below:

TABLE 1

| | | | | Resonance |
|---|---|---|---|---|
| | Length | Thickness | | frequency |
| Condition | (mm) | (t) | Number | (Hz) |
| 1 | 55 | 0.15 | 1 | 318 |
| 2 | 63 | 0.2 | 1 | 290 |

The resonance frequency has a strong resonance force but a slow reaction speed, while the driving frequency different from the resonance frequency has a weak resonance force but a fast reaction speed. Here, the reaction speed may refer to a duration in which a reaction that can be recognizable by the user after the user applies a contact-pressure is made.

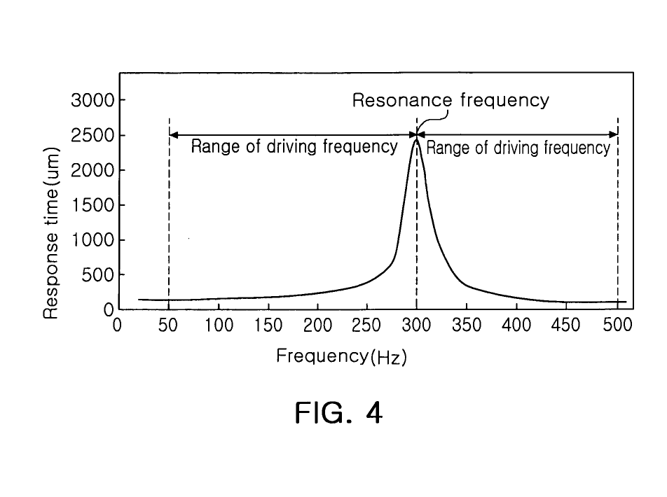

FIG. 4 is a graph showing the relationships between the frequency and response speed of the haptic feedback device according to an exemplary embodiment of the present invention.

As shown in FIG. 4, the driving frequency may be set to be different from the resonance frequency. Namely, the driving frequency may be set to range from 50 Hz to a value not greater than the resonance frequency, or may be set to range from a value exceeding the resonance frequency to 500 Hz. Here, 50 Hz is a frequency at which the user can recognize vibrations, and 500 Hz is a frequency at which a sound is generated along with vibrations. The range of the frequencies is thusly set in terms of the technical meaning.

Meanwhile, the length of the actuator 60 and the vibration plate 40 or the placement position of the actuator 60 on the haptic device 20 is one of the key factors determining a vibration amount of the haptic device 20.

A change in vibration amount over the length of the actuator 60 and the vibration plate 40 will now be described in detail.

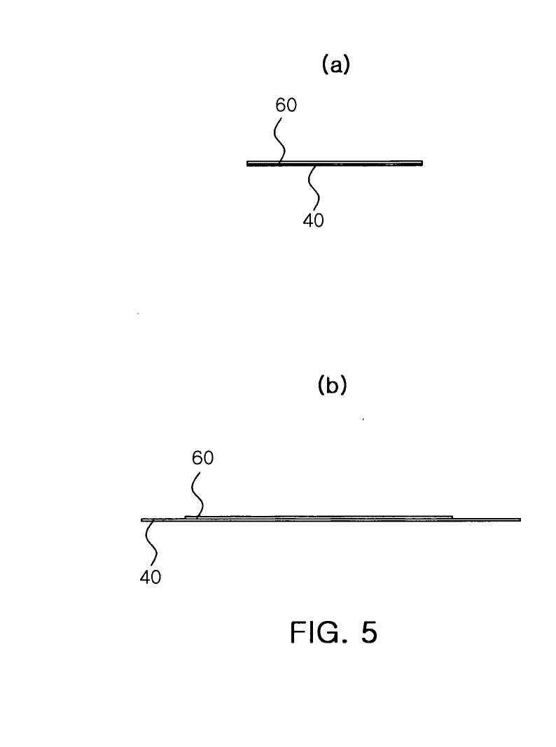

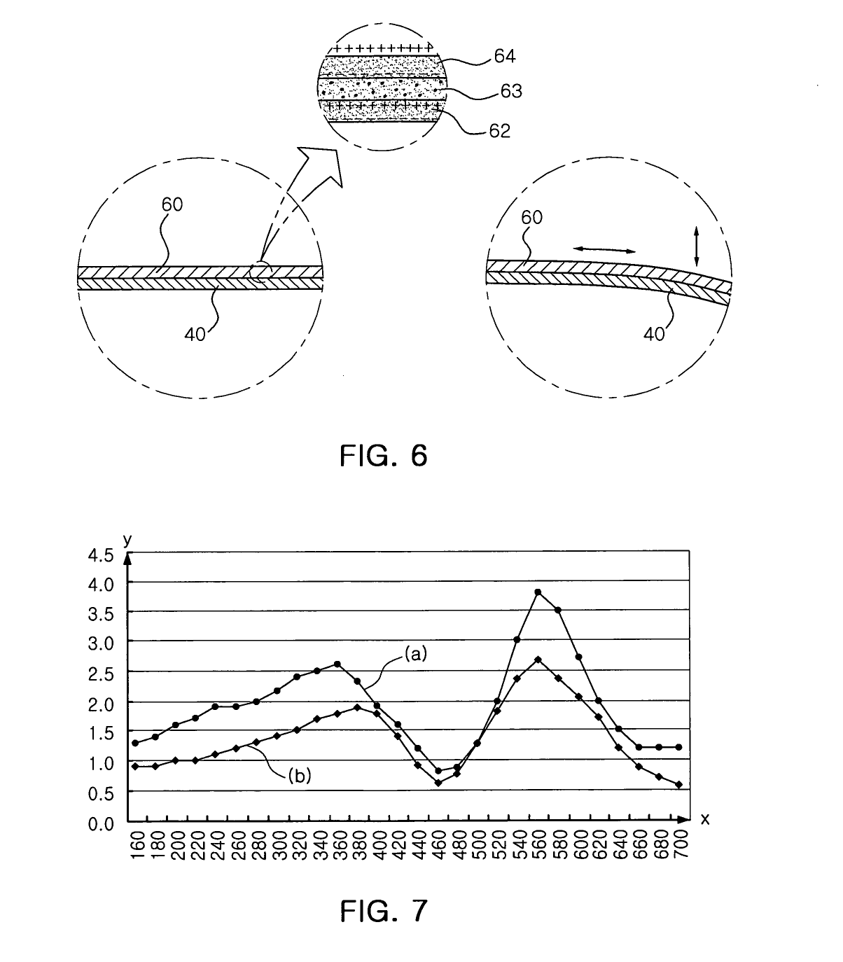

FIGS. 5(a) and 5(b) are side views showing a change in the length of the actuator and the vibration plate of the haptic feedback actuator according to an exemplary embodiment of the present invention. FIG. 6 is an enlarged sectional view of a portion of FIG. 5(b), showing how the haptic feedback actuator operates. FIG. 7 is a graph of a displacement over vibration frequency of the haptic feedback actuator.

FIG. 5(a) shows an example in which the length of the vibration plate 40 and that of the actuator 60 are equal, and FIG. 5(b) shows an example in which the length of the vibration plate 40 is longer than that of the actuator 60.

Here, the displacement (μm) of the haptic device 20 over the number of vibrations (frequency, Hz) was measured by using a piezo actuator as the actuator 60.

As shown in FIG. 6, the piezo actuator is a ceramic laminated body comprising ceramic layers 62 and 64 formed on both sides of an electrode 63 made of silver (Ag) and other impurities, and polling of the ceramic layers 62 and 64 is formed in the same direction.

When the polling of the ceramic layers 62 and 64 is formed in the same direction, the amount of vibration increases compared with a case in which polling is formed in mutually opposing directions, so the polling may be appropriately selected according to a requirement range of vibrations.

When pressure is applied to the piezo actuator in a state that the polling of the ceramic layers 62 and 64 is formed in the same direction, the actuator 60 is displaced in a lengthwise direction while the vibration plate 40 is not displaced.

For this reason, when the actuator 60 is displaced in the lengthwise direction, the haptic feedback actuator vibrates up and down.

FIG. 7 is a graph showing the results (indicated by (a) and (b)) obtained by measuring vertical displacements of the haptic device 20 while increasing the number of vibrations of the examples of FIG. 5(a) and FIG. 5(b).

With reference to FIG. 7, it is noted that the example of FIG. 5(a) shows a greater displacement compared with the example of FIG. 5(b).

Thus, the length of the vibration plate 40 and the actuator 60 can be appropriately selected to be used according to the vibration requirement range of the electronic device.

The amount of vibration of the haptic device 20 according to the placement position of the actuator 60 on the haptic device 20 will now be described in detail.

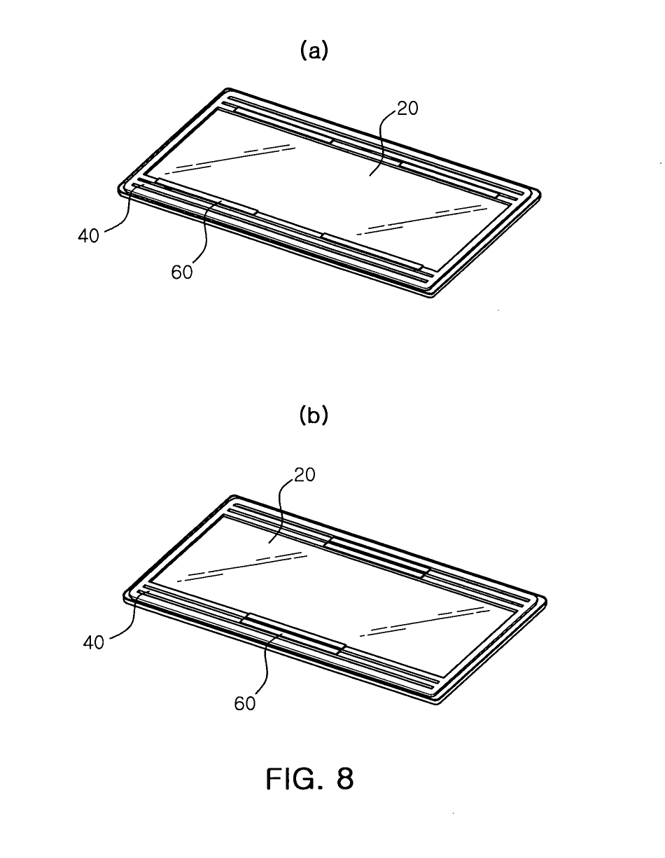

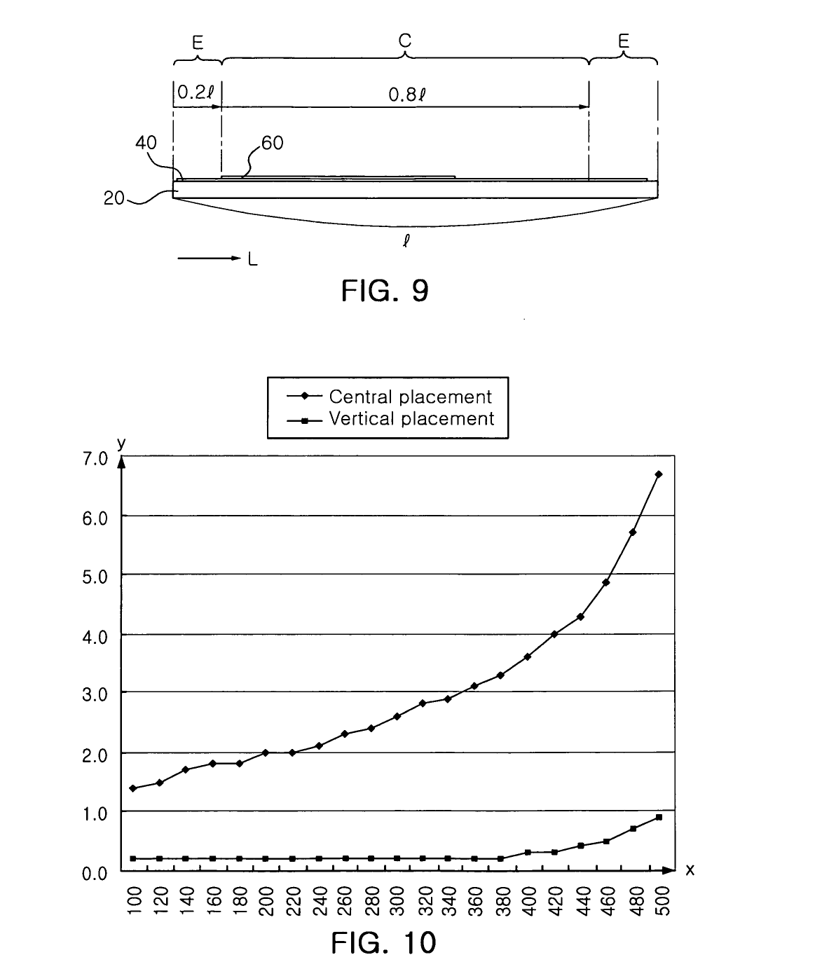

FIGS. 8(a) and 8(b) are schematic perspective views showing a change in the placement position of the actuator of the haptic feedback actuator according to an exemplary embodiment of the present invention. FIG. 9 is a side view for explaining the placement position of the actuator according to an exemplary embodiment of the present invention. FIG. 10 is a graph of displacement over vibration frequency of the haptic feedback actuator of FIGS. 8(a) and 8(b).

FIG. 8(a) shows an example in which the actuator 60 is aligned in a row in the lengthwise direction on the display panel 22, namely, the haptic device, and FIG. 8(b) shows an example in which the actuator 60 is collectively disposed in parallel at a central portion of the display panel 22.

Here, the central portion of the display panel 22 may refer to a widthwise directional central portion based on the entire display panel 22 or may be a lengthwise directional central portion (C).

With reference to FIG. 9, the central portion (C), at which the actuator 60 is disposed, may be set to have a range from 20 percent to 80 percent of the entire length of the display panel from one end portion of the display panel to the other end portion. Other portions will be set as edge portions (E) for the sake of convenience.

Meanwhile, the vibration plate 40 may be selectively employed according to a vibration requirement range of the electronic device.

FIG. 10 is a graph showing the results obtained by measuring a vertical displacement of the haptic device 20 while increasing the number of vibrations by applying a contact-pressure to the foregoing examples.

With reference to FIG. 10, it is noted, in the exemplary case in which an actuator 60 is disposed at the central portion of the display panel 22, that as the number of vibrations increases, the displacement increases in geometrical progression.

Thus, the position for disposing the actuator 60 on the haptic device 20 may be appropriately selected according to the vibration requirement range of the electronic device.

Hereinafter, examples of changing an adhesive for bonding the haptic device 20 and the vibration plate 40, and an adhesive for bonding the vibration plate 40 and the actuator 60 will be described in detail.

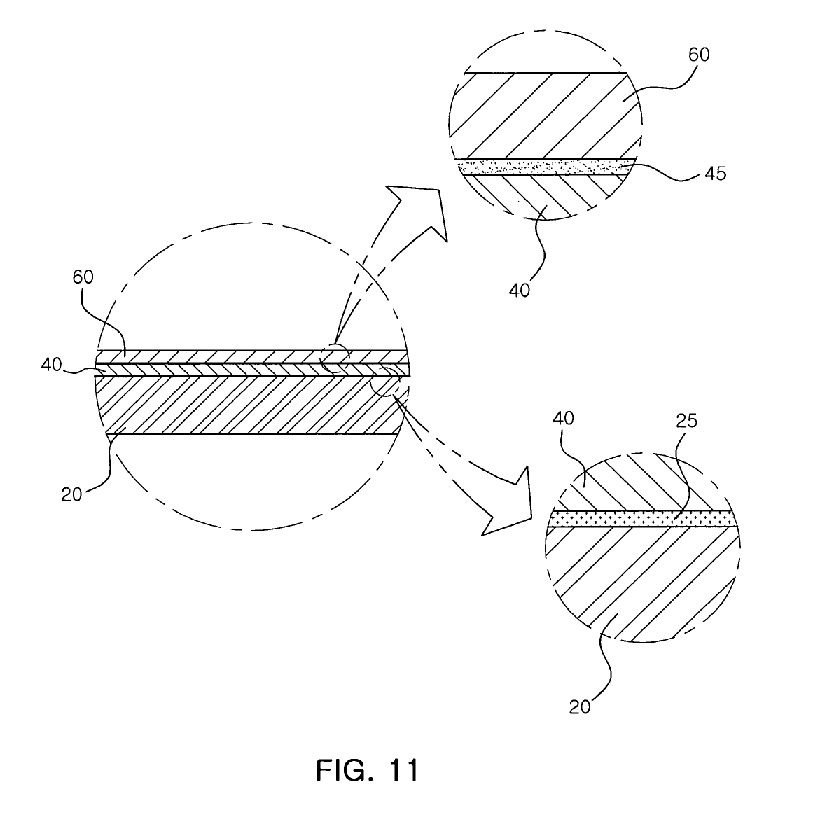

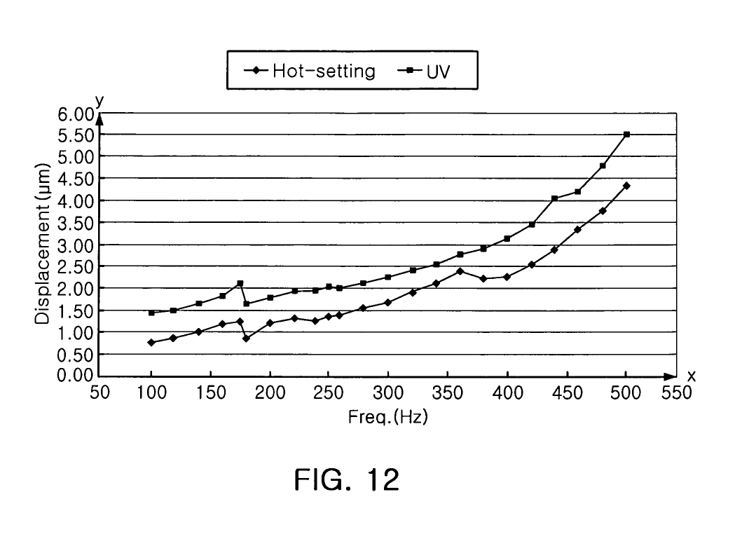

FIG. 11 is a schematic sectional view showing how the haptic feedback device is bonded according to an exemplary embodiment of the present invention. FIG. 12 is a graph of a displacement over vibration frequency of the haptic feedback actuator measured according to types of bonding materials of the haptic feedback device according to an exemplary embodiment of the present invention.

With reference to FIG. 12, an anaerobic adhesive 25 is used for bonding the haptic device 20 and the vibration plate 40, and a hot-setting adhesive 25 is used is used to bond the vibration plate 40 and the actuator 60.

The anaerobic adhesive 25 may seal air, clean, and be resistant to vibration impact. Here, the anaerobic adhesive 25 may be a UV adhesive.

In order to properly transfer vibrations at their maximum level without a displacement of the haptic device 20, the anaerobic adhesive 25 that properly transfers vibrations, as compared with an adhesive made of rubber, is selected.

Meanwhile, the hot-setting adhesive 45, which has a stronger adhesive force and maintains variations in rigidity, as compared with the vibration transfer, needs to be used to bond the vibration plate 40 and the actuator 60.

FIG. 12 is a graph of displacements over a change in a vibration number according to the anaerobic adhesive 25 and the hot-setting adhesive 45. It is noted that the anaerobic adhesive 25 shows a drastic increase in the vibration amount according to the increase in the vibration number, while the hot-setting adhesive 45 shows a relatively low increase in the vibration amount, compared with the anaerobic adhesive 25, according to the increase in the vibration number but ensures firm bonding (or fixing).

As set forth above, in the haptic feedback actuator, the haptic feedback device, and the electronic device according to exemplary embodiments of the invention, the size of the electronic device can be reduced compared with the case in which a vibration motor is employed, and utilization of the internal space of the electronic device can be increased.

Also, because frequencies are differentiated according to vibration ranges required for the electronic device, the haptic feedback device can be applicable to various applications, and because the placement position or length of the actuator can be variably selected, the haptic feedback device can be applicable to various applications.

In addition, because the electronic device does not need vibrated overall, the present invention is very effective in terms of power consumption.

Moreover, various types of feedback can be implemented in line with recent advancements in user interfaces.

While the present invention has been shown and described in connection with the exemplary embodiments, it will be apparent to those skilled in the art that modifications and variations can be made without departing from the spirit and scope of the invention as defined by the appended claims.

What is claimed is:

1. A haptic feedback device comprising:
a haptic device to which contact pressure is applied;
an actuator provided in the haptic device and excited according to a change in the contact pressure of the haptic device to generate vibrations; and
a controller controlling the actuator to vibrate at a pre-set resonance frequency in a pre-set first operation mode and vibrate at a driving frequency different from the resonance frequency in a second operation mode set to be different from the first operation mode.

2. The device of claim 1, wherein the driving frequency is lower than the resonance frequency, or 50 Hz or higher.

3. The device of claim 1, wherein the driving frequency is higher than the resonance frequency, or 500 Hz or lower.

4. The device of claim 1, wherein the actuator is disposed at a central portion of the haptic device.

5. The device of claim 1, wherein the actuator is disposed at a central portion of an edge portion in a lengthwise direction of the haptic device.

6. The device of claim 4, wherein the central portion, at which the actuator is disposed, is within the range of 20 percent to 80 percent of the overall length of the haptic device from one end portion to the other end portion of the haptic device.

7. The device of claim 5, wherein the central portion, at which the actuator is disposed, is within the range of 20 percent to 80 percent of the overall length of the haptic device from one end portion to the other end portion of the haptic device.

8. The device of claim 1, wherein the actuator is a piezo actuator or a polymer actuator.

9. The device of claim 1, wherein the haptic feedback device further comprising:
a vibration plate interposed between the haptic device and the actuator and transferring vibrations generated from the actuator to the haptic device.

10. The device of claim 9, wherein the vibration plate comprises a plurality of ramification lines formed on the edge portion in a lengthwise direction of the haptic device, and the ramification lines are demarcated by a slit.

11. The device of claim 10, wherein the actuator is attached to ramification lines and is disposed to be parallel to the ramification lines.

12. An electronic device comprising:
a case having an internal space;
a display panel disposed within the case;
an actuator excited according to a change in contact pressure of the display panel to generate vibrations; and
a controller controlling the actuator to vibrate at a pre-set resonance frequency in a pre-set first operation mode and vibrate at a driving frequency different from the resonance frequency in a second operation mode set to be different from the first operation mode.

13. The device of claim 12, wherein the driving frequency is lower than the resonance frequency, or 50 Hz or higher.

14. The device of claim 12, wherein the driving frequency is higher than the resonance frequency, or 500 Hz or lower.

15. The device of claim 12, wherein the actuator is disposed at a central portion of an edge portion in a lengthwise direction of the display panel.

16. The device of claim 12, wherein the actuator is disposed at a central portion of the display panel.

17. The device of claim 15, wherein a central portion, at which the actuator is disposed, is within the range of 20 percent to 80 percent of the overall length of the display panel from one end portion to the other end portion of the display panel.

18. The device of claim 16, wherein a central portion, at which the actuator is disposed, is within the range of 20 percent to 80 percent of the overall length of the display panel from one end portion to the other end portion of the display panel.

19. The device of claim 12, further comprising:
a vibration plate interposed between the display panel and the actuator and transferring vibrations generated from the actuator to the display panel.

20. The device of claim 19, wherein the vibration plate comprises a plurality of ramification lines formed on the edge portion in a lengthwise direction of the display panel, and the ramification lines are demarcated by a slit.

21. The device of claim 20, wherein the actuator is attached to ramification lines and is disposed to be parallel to the ramification lines.

22. The device of claim 12, wherein the actuator is a piezo actuator or a polymer actuator.

23. The device of claim 22, wherein the piezo actuator is a ceramic laminated body, and polling of the ceramic laminated body is formed in the same direction.
